(19) United States
(12) Patent Application Publication
(10) Pub. No.: US 2011/0079118 A1
(43) Pub. Date: Apr. 7, 2011

(54) HAND TOOL

(75) Inventor: LARRY LEE, Taichung (TW)

(73) Assignee: TIEN-I INDUSTRIAL CO., LTD, TAICHUNG (TW)

(21) Appl. No.: 12/774,573

(22) Filed: May 5, 2010

(30) Foreign Application Priority Data
Oct. 2, 2009 (TW) 098218243

(51) Int. Cl. B25B 23/16

(52) U.S. Cl. 81/177.7

(57) ABSTRACT

A hand tool of the present invention includes a main body and a sleeve element. The sleeve element is rotatably disposed on the main body. As such, a using can hold the sleeve element while rotating the main body quickly to drive a workpiece.

### BACKGROUND OF THE INVENTION

1. Field of the Invention

The present invention relates to a hand tool.

2. Description of the Prior Art

T-shaped hand tools are a common type of the hand tools. They mainly includes a vertical rod and a transverse rod, in which the vertical rod is for driving a workpiece, and the transverse rod is for the user to grip and apply force thereon. The T-shaped hand tool can increase the torque force, yet it is inconvenient for a user to quickly turn the transverse rod single handed with another hand holding the vertical rod.

A T-shaped hand tool may be provided with a rotatable sleeve to resolve the above mentioned problem. As disclosed in U.S. Pat. No. 7,387,053, the rotatable sleeve includes a tubular member 31, an actuating device 50 and several bearings 34 and 56. A ball 41 is installed on the rotatable sleeve to combine the rotatable sleeve with the vertical rod 10. Since there is only one ball being presented, the bearings 34 and 56 cannot be omitted from the rotatable sleeve in order to make the sleeve smoothly rotatable about the vertical rod 10. As, such, the weight as well as the cost of the T-shaped hand tool are high. Other similar tool is also disclosed in TW M315141.

### SUMMARY OF THE INVENTION

The main object of the present invention is to provide a quickly-operable hand tool.

To achieve the above and other objects, a hand tool of the present invention includes a main body and a sleeve element. The main body includes a handle portion and a working portion disposed on the handle portion. The working portion is formed with an annular groove on a periphery thereof The sleeve element includes a first sleeve, a second sleeve and several ball members. The first sleeve is tube shaped and rotatably disposed on the working portion, and the first sleeve is formed with several through holes corresponding to the annular groove for the ball members to dispose therein. The second sleeve is fixed to the first sleeve and abuts against one side of each ball member. An opposite side of each ball member is, therefore, protrusive from its corresponding through hole and engages with the annular groove. As such, a user can quickly and easily operate the hand tool of the present invention by holding the sleeve element with one hand and rotating the handle portion with another.

Thereby, the conventional tools with several bearings and only one ball are modified by the present invention, which provides several ball members and an annular groove to separate the forces applied on the ball members. Furthermore, the ball members of the present invention is 360-degree-rotatable. As such, the hand tool of the present invention is more economic and more durable.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing showing a hand tool of the present invention;

FIG. 2 is a partial profile showing a hand tool of the present invention;

FIG. 3 is a perspective view showing a hand tool of the present invention;

FIG. 4 is a profile showing a first sleeve of the present invention;

FIG. 5 is an AA profile of the first sleeve of FIG. 4;

FIG. 6 is a lateral profile of a first sleeve in accordance with another embodiment of the present invention;

FIG. 7 is a perspective drawing showing a hand tool in accordance with yet another embodiment of the present invention;

FIG. 8 is a perspective drawing showing a hand tool in accordance with yet another embodiment of the present invention.

### DETAILED DESCRIPTION OF THE PREFERRED EMBODIMENTS

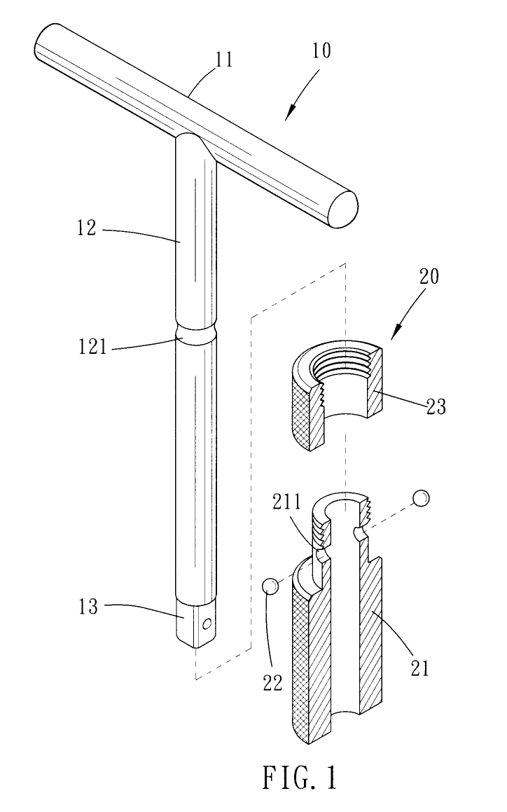

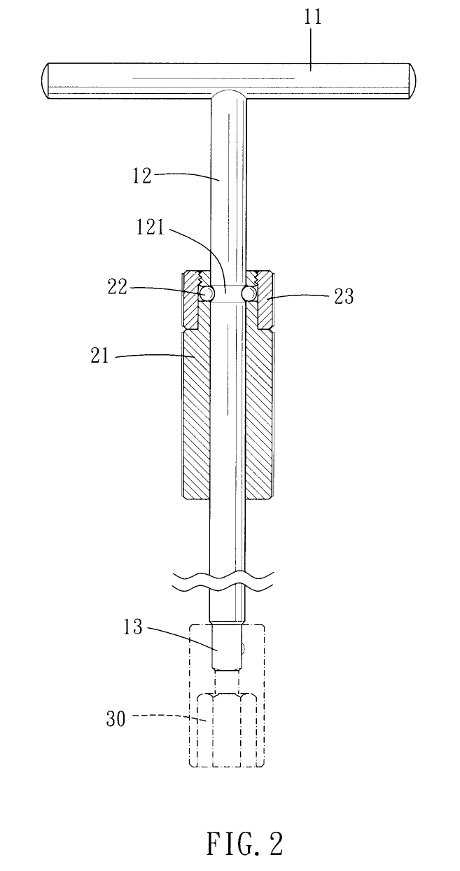

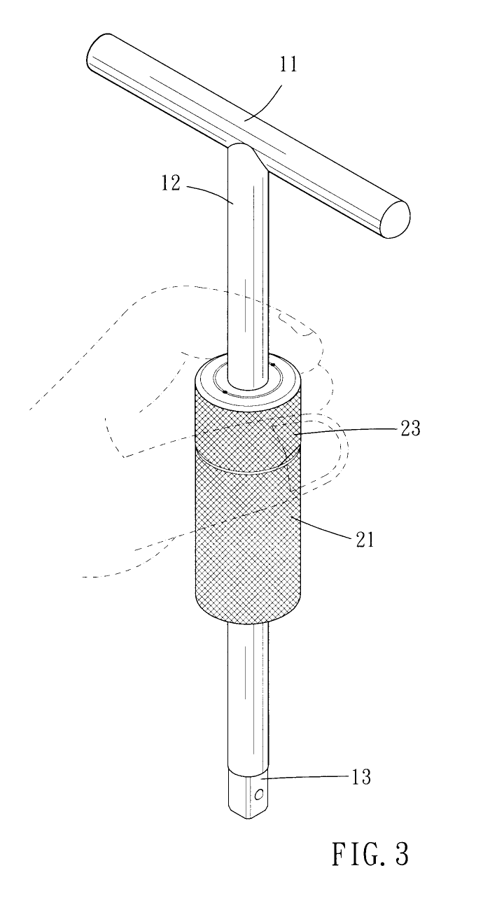

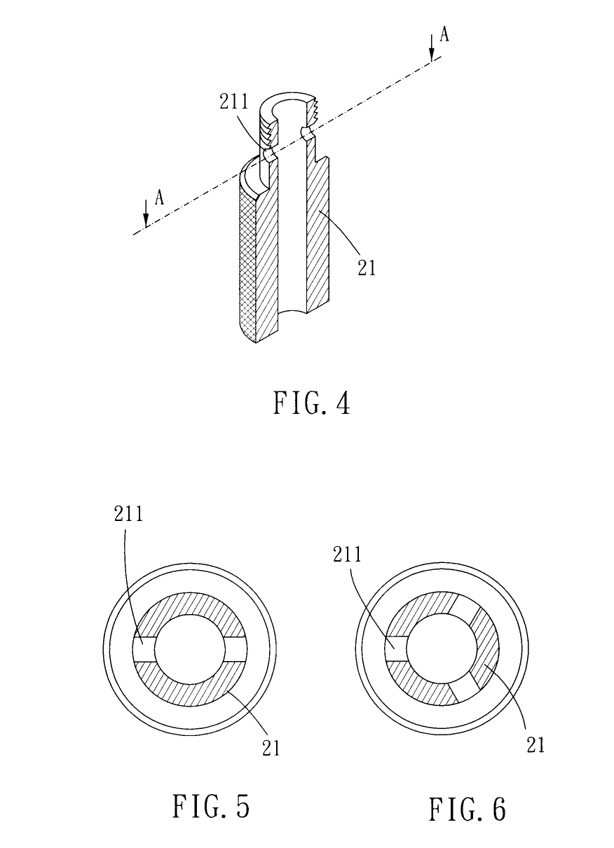

Please refer to FIG. 1 to FIG. 5. A T-shaped hand tool of the present invention includes a main body 10 and a sleeve element 20.

The main body 10 includes a handle portion 11 and a working portion 12 disposed on the handle portion 11, either directly or indirectly. Preferably, the handle portion 11 is normal to the working portion 12. As such, the main body 10 is substantially T-shaped. The working portion 12 has a distal end, which can be formed as a polygonal, such as hexagonal, driving head, or cross-shaped or I-shaped screwdriver tip to directly drive a workpiece. Or, the distal end of the working portion 12 can be mounted with an adaptor 30 to indirectly drive a workpiece. In addition, the main body 10 can rotate about an axis of the working portion 12 as the hand tool is operated. Since the user applies force on the handle portion 11, a larger torque force is generated for the user to drive the workpiece force-savingly. Moreover, the working portion 12 is formed with an annular groove 121 on a periphery thereof.

The sleeve element 20 includes a first sleeve 21, a second sleeve 23 and two ball members 22. The first sleeve 21 is tube shaped and rotatably disposed on the working portion 12, and the first sleeve 21 is formed with two through holes 211 corresponding to the annular groove 121 for the ball members 22 to respectively dispose therein. The second sleeve 23 is fixed to the first sleeve 21 and abuts against one side of each ball member 22. An opposite side of each ball member 22 is, therefore, protrusive from its corresponding through hole 211 and engages with the annular groove 121. Preferably, the second sleeve 23 is threaded on the first sleeve 21. To detachably fixed the sleeves 21 and 23, a rotation-free means is provided for preventing the second sleeve 23 from rotating about the first sleeve 21 as they are threaded with each other. The rotation-free means can be a deformation means that deforms the threaded sections of the sleeves 21 and 23 by hammering the threaded sections with a sharp-headed tool. Furthermore, the rotation-free means can also be a welding means, adhesive means and the like. In addition, the through holes 211 are preferably spaced formed on the first sleeve 21, and the amount of the through holes 211 as well as the ball members 22 can be more than two, as shown in FIG. 6. For friction-increasing purpose, an outer surface of the sleeve element 20 is formed with gripping grooves. Specifically, both the outer surfaces of the first and second sleeves 21 and 23 are formed with the gripping grooves.

When a user utilizes the hand tool of the present invention to drive a workpiece, the user just simply hold the sleeve element 20 with one hand and apply force on the handle portion 11 with another hand. As the force is applied on the main body 10, the user can release his another hand off the handle portion 11, making the main body 10 to turn by its inertia. Due to the rotatable relationship between the sleeve element and the main body, the workpiece can, therefore, be driven quickly and force-savingly. Note that the present invention introduces that the ball members 22 are spaced disposed on the sleeve element 20, thus bearings are no longer necessary in the present invention for the sleeve element 20 to smoothly rotate about the working portion 12. As such, the weight and the cost of the hand tool of the present invention are significantly reduced for these and other reasons.

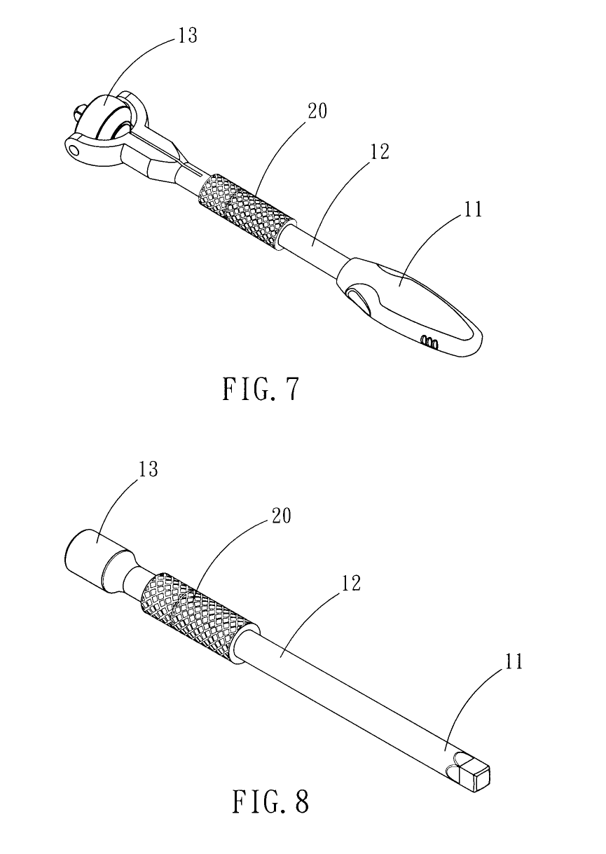

Please refer to FIG. 7 and FIG. 8. The present invention can also be applied to hand tools other than T-shaped wrench as discussed hereinabove. As shown in FIG. 7, the working portion 13 can be a rotatable ratchet member. As shown in FIG. 8, the handle portion 11 is formed with a polygonal unit, and the working portion 13 is a sleeve.

What is claimed is:

1. A hand tool, comprising:
a main body, comprising a handle portion and a working portion disposed on the handle portion, the main body being rotated about an axis of the working portion as the hand tool being operated, the working portion being formed with an annular groove on a periphery thereof;
a sleeve element, comprising, a first sleeve, a second sleeve and several ball members, the first sleeve being tube shaped and rotatably disposed on the working portion, the first sleeve being spaced formed with several through holes corresponding to the annular groove, the ball members being installed in the through holes, the second sleeve being fixed to the first sleeve and abutting against one side of each ball member, an opposite side of each ball member being protrusive from its corresponding through hole and engaging with the annular groove.

2. The hand tool of claim 1, wherein an outer surface of the sleeve element is formed with gripping grooves.

3. The hand tool of claim 2, wherein the second sleeve are threadedly disposed on the first sleeve, a rotation-free means is provided for preventing the second sleeve from rotating about the first sleeve as the second sleeve is threaded on the first sleeve.
